(19) United States
(12) Patent Application Publication
(10) Pub. No.: US 2010/0049569 A1
(43) Pub. Date: Feb. 25, 2010

(54) System and Method for Quantity and Timed Limited Asynchronous Cost Recovery

(75) Inventors: Dmytri Bazulin, Prevost (CA); Clayton Kramer, Oakland, CA (US); Michael Cahill, San Rafael, CA (US); Jeremy Evans, Lafayette, CA (US); Raymond Bradley, Walnut Creek, CA (US)

Correspondence Address: Law Offices of Daniel L. Dawes;Dawes Patent Law Group, 5200 Warner Blvd, Ste. 106, Huntington Beach, CA, 92649, US

(73) Assignee: Sepialine Inc., San Francisco, CA (US)

(21) Appl. No.: 12/330,440

(22) Filed: Dec. 8, 2008

Related U.S. Application Data
(63) Continuation-in-part of application No. 12/194,863, filed on Aug. 20, 2008, now abandoned.

(51) Int. Cl. G06Q 10/00; G06F 15/16; G06Q 50/00; G06Q 30/00

(52) U.S. Cl. 705/8; 709/204; 705/30

(57) ABSTRACT

An asynchronous two-dimensional limiting cost recovery system includes an expense activity sent from a client computer to a server computer. The extracted data is sent to a central message queue, where the client computer reads the data and graphically notifies the user of unbilled expense activity. An administrator defines a quota which determines how many unbilled expense activities can exist for a given user before a mandatory billing interface is displayed regardless of how much time it took to complete those activities, or defines a maximum time duration which determines how much time a user is given before a mandatory billing interface is displayed regardless of how many expense activities were completed, or both, whichever occurs first. A “snooze” option works in conjunction with the quota and maximum time duration limitations.

### BACKGROUND OF THE INVENTION

1. Field of the Invention

The invention relates to the field of cost recovery in a computer network, and in particular to a system and method for asynchronously limiting printing events based on quota and time frame parameters.

2. Description of the Prior Art

In recent years, it has become increasingly desirable for businesses to quantify their printing and print media costs, both for the purpose of cost allocation and to allow them to recoup related expenses. This is of particular concern for professionals such as architects and engineers, since the services provided by such professionals may require the printing of blueprints and other large-format technical documents. The printing of such documents is costly, and thus the ability to recoup these costs through a cost recovery system is of great value.

Prior to describing the attributes of existing cost recovery systems, the general layout of a computer network in which such a system may be installed will be described by way of illustration. An office computer network generally contains each of the following elements: 1. a plurality of client computers from which print jobs originate; 2. a network through which the client computers and other system components are interconnected; 3. one or more users who generate print jobs while logged in to the computer network through a client computer; 4. print jobs, which possess inherent attributes such as quantity and page dimensions; 5. at least one printer, from which printed physical media is physically printed; and 6. a server computer, which is responsible for queuing and directing traffic to the printer(s). In addition, many office computer networks that include cost recovery also include the following additional components: 1. a component designed to detect expense activity and extract relevant expense activity information; 2. A graphical user interface (GUI) for providing billing information (the billing dialog) to each user; 3. a central database to which data about expense activity is recorded; 4. a management interface from whence the cost recovery system can be controlled; and 5. a reporting interface through which expense activity data can be viewed.

Any cost recovery system must both capture expense activity, namely any printing, copying, scanning, or faxing, and then prompt a responsible user to allocate that expense to a particular billing code, department, project, job, etc. Maintaining a factual record describing all expense activity on a computer network is the first requirement of a cost recovery solution. This type of data is considered factual and inherent to an expense activity, and can be extracted automatically from a expense activity without user intervention.

Once reliable expense activity detection has been established, it is necessary to elaborate on the resultant data records for accounting purposes. Data not inherent to an expense activity must be supplied by a user and then appended to an existing factual record. Such data may include, but is not limited to, the related project number; the related client number; the sub-project or phase number; the status of the project; and any additional user comments. These appended data fields allow the office administration or accounting personnel to generate invoices, cost estimates, and other business metrics to assist in the overall efficiency of the office and to allow the office to recoup what would otherwise be overhead costs.

Although the proper entry of qualification (billing-related) data is necessary in order for a cost recovery system to achieve its goals, users are generally reluctant to enter such data. Users may see the process of entering such data as time-consuming or as a distraction from their immediate goals of completing a technical or professional project. Cost recovery systems must therefore employ some sort of enforcement mechanism in order to ensure that users supply the qualification data in a complete and timely manner. Two enforcement methods have generally been used in existing cost recovery systems.

The first enforcement method, which may be referred to as the “hostage” method, is to interrupt the expense activity and prevent it from completing until the user has adequately complied with the cost recovery system's qualification data requirements. Thus for example a user who requests an expense activity such as printing or faxing may immediately be presented with a GUI (graphical user interface) in which to provide the necessary qualification data. If the user does not enter all required data, the user's expense activity will not be sent to the server for execution.

The second enforcement method, which may be referred to as the “post billing” technique, prompts the user for necessary qualification data after the expense activity has been completed. The benefits of this “post billing” technique are many. For example, one primary benefit is the ability to defer billing until such time as is convenient for the end user. However, a limit must be placed on billing deferral. Current prior art cost recovery systems limit deferral on the basis of quantity, meaning that an administrator sets a quota, which defines the maximum number of unbilled expense activities a user is allowed to accumulate before the cost recovery software requires billing information.

Having a billing deferral system based on a quota limitation is effective. Particularly end users find it convenient to defer billing to a later time, while administrators can place limits on an entire company, or set different limits for different users, or for groups of users. However a potential pitfall of the quota technique is that users who print infrequently will not be required to provide billing information for a potentially indefinite amount of time. By the time such a user is presented with a billing interface, the user may no longer remember the specifics of the job performed and may, hence, be unable to provide accurate accounting information.

The limitations of the prior art are overcome by the present invention as described below.

### BRIEF SUMMARY OF THE INVENTION

The present invention comprises an asynchronous two-dimensional limiting cost recovery system. In this two-dimensional scheme, an expense activity such as a print, copy, scan, or fax job is sent from a client computer to a server computer, where its existence is detected, and where data about the expense activity is extracted. The extracted data is sent to a central message queue, where the client computer reads the data and graphically notifies the user of the existence of unbilled expense activity. Billed expense activity information is preferably written to a central location, where a management interface allows for viewing and reporting of expense data.

In contrast to the “hostage” and “post billing” enforcement methods described above, the present invention comprises what may be termed a “dual limiting” enforcement method. This enforcement method allows the expense activity to pass unhindered from the client computer to the server, and then to the printer. An administrator defines a quota which determines how many unbilled expense activities can exist for a given user before a mandatory billing interface is displayed, regardless of how much time it took to complete those activities. The administrator also defines a maximum time duration which determines how much time a user is given before a mandatory billing interface is displayed, regardless of how many expense activities were completed.

Alternatively, the administrator may set the system for whichever event occurs first thus displaying the mandatory billing interface at the most efficient and accurate reporting time. While a given user's unbilled expense activity count is below the quota or while the billing time period is below the maximum time duration, the user may recall the billing interface at his or her discretion. The user may thus delay the entry of the required billing information to a convenient time, but cannot avoid entering the information and cannot indefinitely delay the entry of the information to a point where the user may no longer recall the pertinent information. Enforcement is preferably accomplished once the quota is reached or when the specified billing time period has ended by obscuring the computer screen with the billing interface. Though other processes on the client computer are not interrupted, the user is essentially unable to use the computer without sufficiently addressing, then dismissing, the billing interface.

Many of the advantages of the present invention flow from the separation of detection (phase 1) and billing (phase 2) of expense activity, and the use of a quota- and time-based message queue between the separate phases. The present invention allows native print processes to flow undisturbed by the requirement to enter billing information. Decoupling detection and billing eliminates the onerous enforcement techniques found in the prior art. It should be noted that in the asynchronous model of the present invention, the act of writing data about an expense activity to a database preferably takes place when the billing data is supplied; this contrasts with some systems in which the writing of data may or may not occur at or near the time when the expense information is extracted and stored. In the asynchronous model, the moment that the factual information concerning an expense activity is extracted, it is recorded in a message queue. The user is then prompted to supply additional billing information.

The present invention is based on the view that expense activities should remain a native process, and takes a “hands off the process” approach that makes few if any modifications to the process of the expense activity being performed. Thus at the core of the present invention is an intention to impose the fewest restrictions upon users while maintaining a reliable record of expense events for cost allocation and recoupment.

It is thus an object of the present invention to provide an asynchronous cost recovery system in which the processes of detecting and billing an expense activity are decoupled.

It is another object of the present invention to provide a cost recovery system utilizing a “dual limiting” enforcement method.

It is yet another object of the present invention to provide a cost recovery system that reduces the restrictions placed upon users while still ensuring that all required information for expense activities will be tracked.

It is a further object of the present invention to provide a cost recovery system that will properly track expense activities that are sent for completion but are not completed due to the failure of a printer, copier, fax machine, server, or the network.

It is a further object of the present invention to allow users to delay entry of billing information related to a print job for a limited period, while still requiring such information to be entered at a later time.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a diagram illustrating the initial steps in a preferred embodiment of the present invention.

FIG. 2 is a diagram illustrating subsequent steps to those of FIG. 1 in a preferred embodiment of the present invention.

FIG. 3 is a diagram illustrating the final steps in a preferred embodiment of the present invention.

FIG. 4 is diagram illustrating an example of the graphical user interface that is displayed to a network administrator when setting an expense activity quota, maximum billing time duration, or both.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

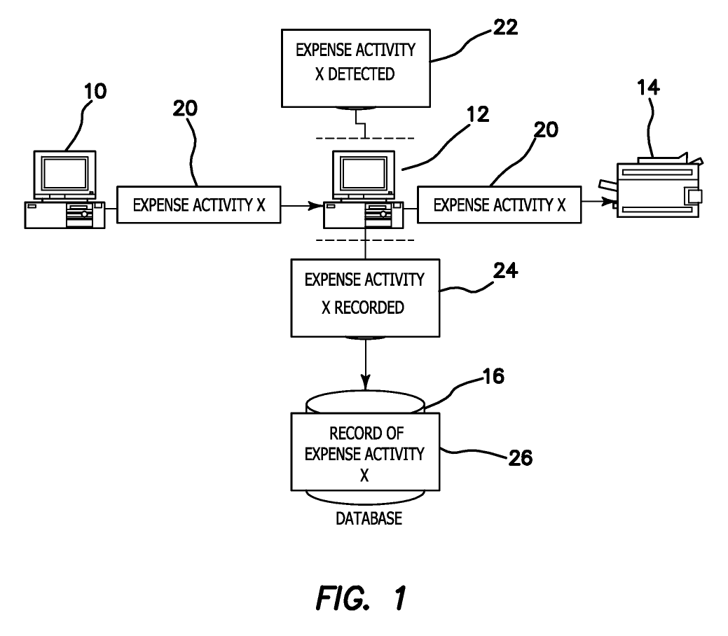

In a preferred embodiment, the invention is implemented using a client/server network as illustrated in FIGS. 1-3. The network comprises a plurality of client computers 10 that are in communication with one or more servers 12. Servers 12 are in communication with one or more printers 14. At least one of client computers 10 and servers 12 are also in communication with a database 16. Each of client computers 10, server 12, printer 14, and database 16 may be of many different configurations and designs as are well known in the art. Client computers 10, server 12, printer 14, and database 16 communicate over a network, which may be configured as a wired or wireless network as is also well known in the art. The software components of a preferred embodiment of the present invention that are resident on client computers 10 and server 12 are as follows:

1. Printer monitor: The printer monitor is a software routine that monitors print queues for printer activity. Printer monitor is preferably resident on server 12, preferably stored on magnetic disk or other permanent media, and capable of being loaded into the volatile memory of server 12 for execution.

2. Message queue: The message queue provides a place where expense activity may be recorded. The message queue is preferably resident on database 16, which may comprise a magnetic disk or other permanent media.

3. Workstation monitor: The workstation monitor is a software routine that detects when new records are written to the message queue. The workstation monitor is preferably resident on client computer 10, preferably stored on magnetic disk or other permanent media and capable of being loaded into the volatile memory of client computer 10 for execution.

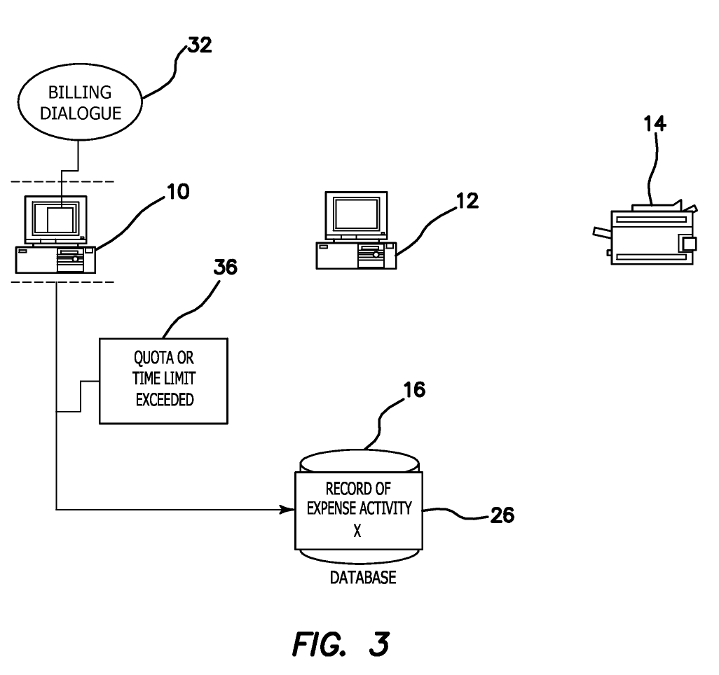

4. Unbilled expense activity alert: The unbilled expense activity alert is a software routine through which a user is alerted to the existence of unbilled activity generated by that user, which unbilled activity alert module is symbolically depicted in FIG. 3 as step 36. Preferably, the unbilled activity alert places a graphical icon in an unobtrusive location on the computer screen of the client computer through which the user is logged in. The unbilled activity alert is preferably resident on client computer 10, preferably stored on magnetic disk or other permanent media and capable of being loaded into the volatile memory of client computer 10 for execution.

5. Billing dialogue: The billing dialogue is a software routine that provides a graphical user interface through which the user may supply information to the record of an expense activity for the purpose of print job qualification, which billing dialogue module is symbolically depicted in FIG. 3 as step 32. The billing dialogue is preferably resident on client computer 10, preferably stored on magnetic disk or other permanent media and capable of being loaded into the volatile memory of client computer 10 for execution.

6. Manager's module: The manager's module is a software routine that allows network administrators to set policies related to all components of the expense tracking system such as setting a quota for the amount of allowable unbilled expense reports or a maximum time duration which may pass before users must input billing information, or both, and view and report on collected expense activity data. The billing dialogue is preferably resident on server 12, preferably stored on magnetic disk or other permanent media and capable of being loaded into the volatile memory of server 12 for execution.

Referring again to FIGS. 1-3, the method of operation for a preferred embodiment of the present invention may now be described. A user is logged in at client computer 10. This user now desires to send an expense activity to a printer 14, fax machine, copier or other peripheral (not shown). The user may execute an expense activity step 20 using the application software resident at client computer 10. For example, a user desiring to print a drawing from a CAD application may execute a “print” command from within that application. The result of executing the print command is the sending of the expense activity at step 20 from client computer 10 to server 12. Server 12, which acts to manage expense activities over the network, may then send the expense activity from server 12 to printer 14 at step 20′.

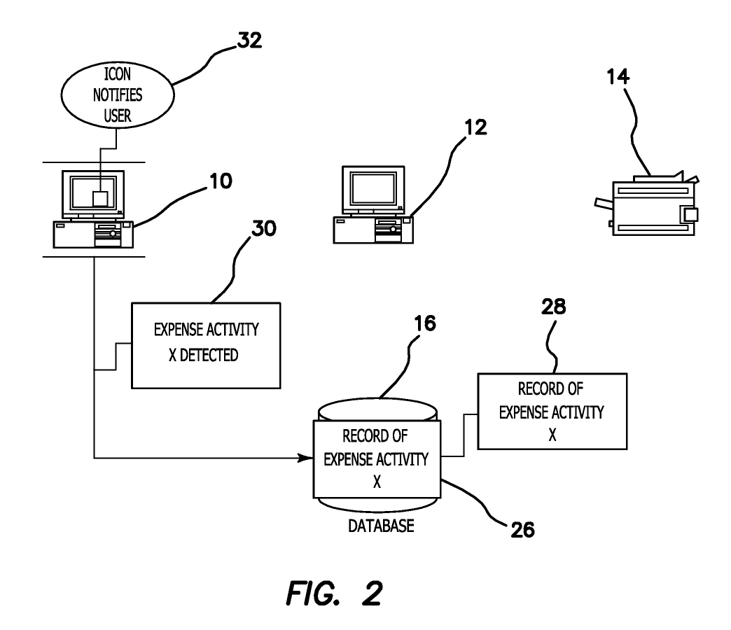

The printer monitor, installed at server 12, detects at step 22 the expense activity step 20. At step 24, the printer monitor extracts relevant information from the expense activity step 20 issued by the user. In FIG. 2 step 28, this information is stored in the message queue resident on database 16 in the form of an expense activity record 26. The information now stored in record 26 will be available to other system components as required. It should be noted that the message queue is preferably capable of storing a large number of records 26 corresponding to expense activities executed by a number of different users at different client computers 10.

The workstation monitor at client computer 10 contains functionality to detect the creation of record 26 at step 30, indicating that an expense activity step 20 was sent by the user at client computer 10. The workstation monitor then notifies the user at client computer 10 that an expense activity step 20 has been sent for which qualification data must be entered. Preferably, the workstation monitor does this in an unobtrusive means, such as by an icon that appears on the screen of client computer 10 at step 32.

The billing dialogue at client computer 10 may be initiated in one of three ways. First, the user may issue a command (preferably by simply clicking on the icon displayed on client computer 10 at step 32) indicating that the user wishes to enter qualification data, occurring at step 34. In this case, a GUI (not shown) appears as a part of the billing dialogue that allows the user to enter the qualification data. The qualification data preferably includes the project number associated with the expense activity; the client number associated with the expense activity; the sub-project or phase number, if any; the status of the project; and any additional user comments. The information entered by the user through the billing dialogue GUI is then entered, along with the information in record 26, in a database, preferably database 16. This information will be used later by, for example, an accounting department for the user in order to properly allocate costs associated with the printing or to generate a bill for the client whose project with which the expense activity is associated. The information in record 26 in the message queue will be deleted upon the completion of this step so that other system components will know that the entry of qualification data for the corresponding expense activity step 20 is completed.

The billing dialogue may also be initiated at step 36 by the user having exceeded a predetermined limit on the number of expense activities that may be entered without the entry of qualification data associated with those expense activities. In order to ensure compliance, the billing dialogue GUI that appears when the quota is reached preferably cannot be moved and obscures other data on the screen, such that client computer 10 is essentially unusable by the user until the billing dialogue is completed. Though the screen is obscured, other processes on the computer are not stopped so that processes already running on the computer are not adversely impacted.

As in the case of voluntary entry of information through the billing dialogue GUI, the successful completion of the billing dialogue results in the storage of the information entered, along with the information in record 26, in a database, preferably database 16. The information in record 26 in the message queue will again be deleted so that other system components will know that the entry of qualification data for the corresponding expense activity step 20 is completed.

The billing dialogue may also be initiated at step 36 by the user having exceeded the maximum time duration for which unbilled expense activities may be entered without the entry of qualification data associated with those expense activities. In order to ensure compliance, the billing dialogue GUI that appears after the maximum time duration has been exceeded preferably cannot be moved and obscures other data on the screen, such that client computer 10 is essentially unusable by the user until the billing dialogue is completed. Though the screen is obscured, other processes on the computer are not stopped so that processes already running on the computer are not adversely impacted. As in the cases of voluntary entry of information and after reaching a pre-selected quota of unbilled expense activities through the billing dialogue GUI, the successful completion of the billing dialogue results in the storage of the information entered, along with the information in record 26, in a database, preferably database 16. The information in record 26 in the message queue will again be deleted so that other system components will know that the entry of qualification data for the corresponding expense activity step 20 is completed.

It is to be expressly understood that when a network administrator is determining which limits to apply to the client computer 10 before the user is required to enter qualification data, both limiting factors, namely quota and time duration, may be used separately or in conjunction with one another. In addition, the assignments may vary from one client computer 10 to another depending on the administrator's discretion. In other words, the network administrator may choose to only limit a specific client computer 10 with a quota, or only with a fixed time duration, or with a combination of both. When both a quota and a maximum time duration is applied to client computer 10, the billing dialogue GUI is displayed after the first event occurs. For example, an administrator sets a quantity limit of five expense activities and a time limit of thirty minutes. If a user prints five jobs over the course of ten minutes, the billing dialogue GUI becomes mandatory once the fifth job is completed. However, if the user prints four jobs and then stops, the billing dialogue GUI becomes mandatory thirty minutes after the first job is completed.

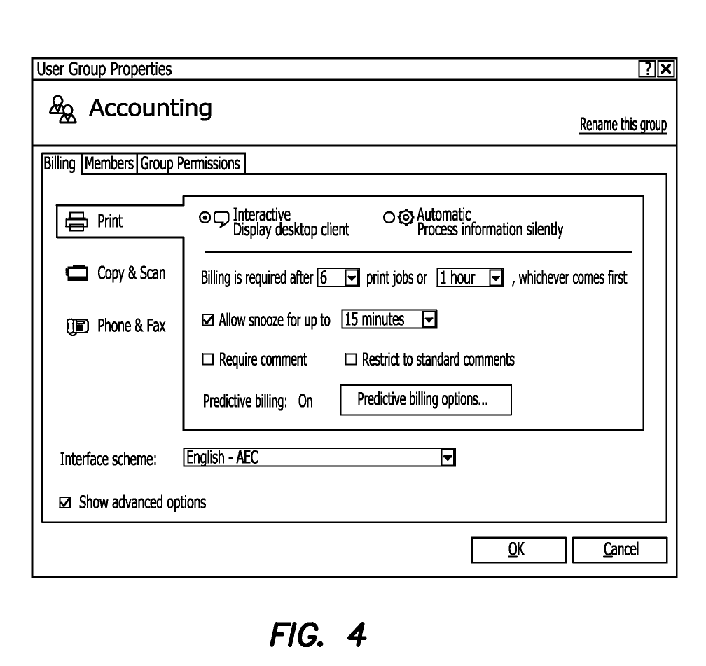

The manager's module at server 12 may serve a number of functions in a preferred embodiment of the invention. One function, as depicted in FIG. 4, is to set the predetermined limits on the number of expense activities that may be sent and the maximum amount of time that may elapse without the entry of qualification data which is needed at step 36 to determine if a quota or time limit has been exceeded. The manager's module at server 12 may also enable a network administrator to view and report on collected expense activity across the network for all users and all client computers 10, and set other system variables related to the various components of the system.

Additionally depicted in FIG. 4 is a “snooze” option that works in conjunction with the quota and maximum time duration limitations described above. The administrator may set up a “snooze” time period for the user to defer entry of qualification data for a specified time period beyond the initial quota or time duration the administrator had originally set. In other words, when the pre-selected number of expense activities has been completed or the maximum time duration has expired, whichever event has occurred first, the user at client computer 10 may decide to hit the “snooze” option and defer the billing dialogue GUI for pre-determined amount of time beginning when the “snooze” option was selected. This provides the user an additional advantage because in situations when entering billing data is not always ideal (such as when in the middle of a project), the user may defer billing until a more convenient time yet is still forced to comply within a reasonable time frame so that important accounting related information does not become forgotten or lost.

Taken together, the use of a quota, a maximum time duration, and a “snooze” option work together to provides cost recovery enforcement, increases the level of accounting accuracy, and preserves user productivity.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. An asynchronous cost recovery system on a computer network including a plurality of client computers and a server, the asynchronous cost recovery system for recouping costs for performance of a expense activity at a first time, comprising:
a message queue module on the server, wherein the message queue is formatted to comprise a plurality of records, and wherein each of the records comprise data pertaining to a plurality of expense activities submitted from the plurality of client computers;
an unbilled print alert module resident on at least one of the plurality of client computers for automatically generating a message of unbilled activity cost data on the corresponding client computer when cost recoupment data is required by the server from the corresponding client computer at a later second time temporally independent from or not synchronous the first time when the expense activity was performed; and
a workstation monitor module resident on the one of the plurality of client computers on which the unbilled print alert module is resident and in communication across the network with the message queue module and with the unbilled activity alert module, wherein the workstation monitor module comprises means for transmitting a message to the unbilled activity alert module if the message queue module contains a record pertaining to a expense activity submitted from the corresponding client computer.

2. The asynchronous cost recovery system of claim 1, wherein the unbilled print alert module generates the message of unbilled print cost data as an icon or a textual message that appears on a computer screen associated with the client computer at the later second time.

3. The asynchronous cost recovery system of claim 1, further comprising a expense activity monitor in communication with the client computer, wherein the expense activity monitor comprises means for monitoring the client computer for the submission of a expense activity from the client computer and to create a record pertaining to the expense activity submitted from the client computer.

4. The asynchronous cost recovery system of claim 3, further comprising a billing dialogue module, wherein the billing dialogue module comprises means for receiving qualification data from the client computer.

5. The asynchronous cost recovery system of claim 4, wherein the billing dialogue module comprises a graphical user interface.

6. The asynchronous cost recovery system of claim 4, further comprising a manager's module, wherein the manager's module comprises means for setting a maximum unbilled expense activity number and/or a maximum time duration for completing an expense activity before the billing dialogue is activated.

7. The asynchronous cost recovery system of claim 6 wherein the manager's module further comprises means for setting an additional time duration to be activated after the original maximum unbilled expense activity number has been met, or the maximum time duration for completing an expense activity has expired, depending on which event occurs first, wherein the additional time duration is shorter than the original maximum time duration.

8. The asynchronous cost recovery system of claim 4, wherein the billing dialogue module further comprises means for forcing qualification data to be entered from the corresponding client computer before proceeding, either when the number of records pertaining to a expense activity submitted by the corresponding client computer exceeds a maximum unbilled expense activity number or when the maximum time duration pertaining to a expense activity has expired, depending on which event occurs first.

9. The asynchronous cost recovery system of claim 8 further comprising means for displaying a graphical user interface on the client computer presenting the user with an option to select an additional time duration to defer entry of qualification data after either when the number of records pertaining to a expense activity submitted by the corresponding client computer exceeds a maximum unbilled expense activity number or when the maximum time duration pertaining to a expense activity has expired, depending on which event occurs first.

10. The asynchronous cost recovery system of claim 9, wherein the billing dialogue module further comprises means for forcing qualification data to be entered from the corresponding client computer before proceeding when the additional time duration for deferring entry of qualification data optioned by the user has expired.

11. The asynchronous cost recovery system of claim 8, wherein the client computer includes a screen and where the billing dialogue module further comprises means for irremovably obscuring the screen of the client computer when the number of records pertaining to a print job submitted by the corresponding client computer exceeds the maximum unbilled expense activity number or when the maximum time duration pertaining to a expense activity has expired, depending on which event has occurred first, until qualification data is entered through the billing dialogue module.

12. The asynchronous cost recovery system of claim 9, wherein the client computer includes a screen and where the billing dialogue module further comprises means for irremovably obscuring the screen of the client computer when the additional time duration optioned by the user has expired, until qualification data is entered through the billing dialogue module.

13. A method for asynchronous cost recovery in a computer network including a plurality of client computers and a server for recouping costs of an expense activity at a first time, comprising:
forming a message queue on the server, wherein the message queue is formatted to comprise a plurality of records, and wherein each of the records comprise data pertaining to a plurality of expense activities submitted from the plurality of client computers;
automatically generating a message of unbilled activity cost data on the corresponding client computer when cost recoupment data is required by the server from the corresponding client computer at a later second time temporally independent from or not synchronous the first time when the expense activity was performed; and
transmitting a message to an unbilled activity alert module if the message queue module contains a record pertaining to a expense activity submitted from the corresponding client computer.

14. The asynchronous cost recovery method of claim 13, further comprising generating an icon or a textual message that appears on a computer screen associated with the client computer at the later second time in the form of a billing dialogue.

15. The asynchronous cost recovery method of claim 14, further comprising monitoring the client computer for the submission of an expense activity from the client computer and to create a record pertaining to the expense activity submitted from the client computer.

16. The asynchronous cost recovery method of claim 15, further comprising receiving qualification data from the client computer.

17. The asynchronous cost recovery method of claim 16, further comprising setting a maximum unbilled expense activity number and/or a maximum time duration for completing an expense activity before the billing dialogue is activated.

18. The asynchronous cost recovery method of claim 17 further comprising setting an additional time duration to be activated after the original maximum unbilled expense activity number has been met, or the maximum time duration for completing an expense activity has expired, depending on which event occurs first, wherein the additional time duration is shorter than the original maximum time duration.

19. The asynchronous cost recovery method of claim 15, further comprising forcing qualification data to be entered from the corresponding client computer before proceeding, either when the number of records pertaining to a expense activity submitted by the corresponding client computer exceeds a maximum unbilled expense activity number or when the maximum time duration pertaining to a expense activity has expired, depending on which event occurs first.

20. The asynchronous cost recovery method of claim 19 further comprising displaying a graphical user interface on the client computer presenting the user with an option to select an additional time duration to defer entry of qualification data after either when the number of records pertaining to a expense activity submitted by the corresponding client computer exceeds a maximum unbilled expense activity number or when the maximum time duration pertaining to a expense activity has expired, depending on which event occurs first.

21. The asynchronous cost recovery method of claim 20, further comprising forcing qualification data to be entered from the corresponding client computer before proceeding when the additional time duration for deferring entry of qualification data optioned by the user has expired.

22. The asynchronous cost recovery method of claim 19, further comprising irremovably obscuring the screen of the client computer when the number of records pertaining to a print job submitted by the corresponding client computer exceeds the maximum unbilled expense activity number or when the maximum time duration pertaining to a expense activity has expired, depending on which event has occurred first, until qualification data is entered through the billing dialogue module.

23. The asynchronous cost recovery method of claim 18, further comprising irremovably obscuring the screen of the client computer when the additional time duration optioned by the user has expired, until qualification data is entered through a billing dialogue module.
